(19) United States
(12) Patent Application Publication
(10) Pub. No.: US 2021/0301842 A1
(43) Pub. Date: Sep. 30, 2021

(54) DRAIN FOR HYDRAULIC SYSTEM

(71) Applicant: DEERE & COMPANY, Moline, IL (US)

(72) Inventors: Andrew J. Kindle, Dubuque, IA (US); Todd M. Vanderlinde, Dubuque, IA (US); John R. Mahrenholz, Dubuque, IA (US)

(21) Appl. No.: 16/836,031

(22) Filed: Mar. 31, 2020

(51) Int. Cl. F15B 21/00; F15B 21/041; F15B 21/0423

(52) U.S. Cl. CPC F15B 21/005; F15B 21/0423; F15B 21/041

(57) ABSTRACT

A hydraulic drain system for a working machine including a hydrostatic pump, a tank, a cooler, a first conduit, and a second conduit. The hydrostatic pump is configured to be driven by a prime mover. The tank is configured to store fluid drained from the hydrostatic pump. The cooler is positioned upstream of the tank. The first conduit couples the hydrostatic pump to the cooler. The second conduit directly couples the hydrostatic pump to the tank.

### BACKGROUND

The present disclosure relates to a hydraulic system for a working machine. More specifically, the present disclosure related to drains for hydraulic systems.

### SUMMARY

In one independent aspect, a hydraulic drain system for a working machine including a hydrostatic pump, a tank, a cooler, a first conduit, and a second conduit. The hydrostatic pump is configured to be driven by a prime mover. The tank is configured to store fluid drained from the hydrostatic pump. The cooler is positioned upstream of the tank. The first conduit couples the hydrostatic pump to the cooler. The second conduit directly couples the hydrostatic pump to the tank.

In another independent aspect, a work vehicle includes a prime mover, a chassis, a plurality of traction members, a work attachment, and a hydraulic system. The plurality of traction members support and propel the chassis along a surface. The work attachment is supported on an end of an arm. The hydraulic drain system for a working machine including a hydrostatic pump, a tank, a cooler, a first conduit, and a second conduit. The hydrostatic pump is configured to be driven by a prime mover. The tank is configured to store fluid drained from the hydrostatic pump. The cooler is positioned upstream of the tank. The first conduit couples the hydrostatic pump to the cooler. The second conduit directly couples the hydrostatic pump to the tank.

In another independent aspect, a hydraulic drain system for a working machine including a first conduit and a second conduit. The first conduit is coupled to a first hydrostatic pump, a second hydrostatic pump, and a cooler. The cooler is positioned upstream of a tank. The second conduit is coupled to the first hydrostatic pump, the second hydrostatic pump, and directly to the tank. The second conduit is not connected to the cooler.

Other aspects of the disclosure will become apparent by consideration of the detailed description and accompanying drawings.

### BRIEF DESCRIPTION OF THE DRAWINGS

FIG. 1 is a perspective view of a work vehicle.

FIG. 2 is a schematic of a hydraulic system of the work vehicle of FIG. 1.

FIG. 3 is a close-up of the hydraulic system of FIG. 2 detailing a hydrostatic pump.

FIG. 4 is a schematic of drain lines of the hydraulic system of FIG. 2.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

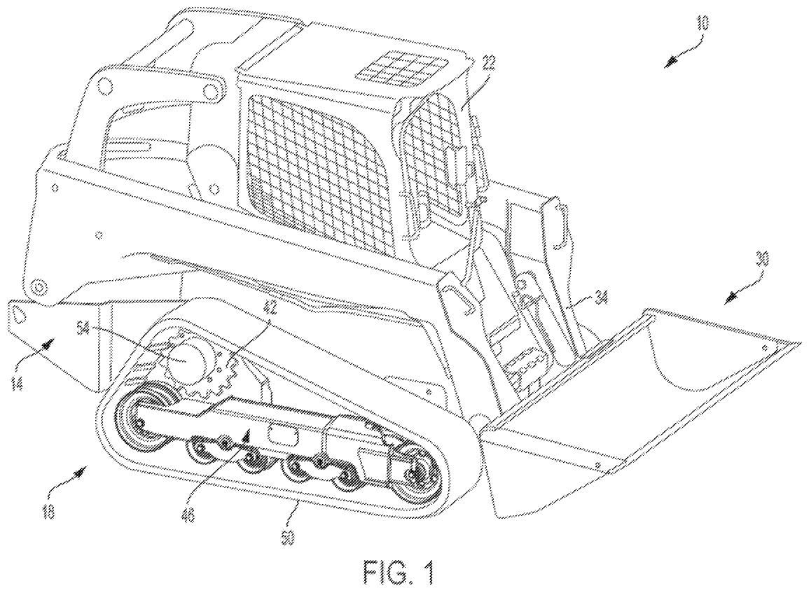

FIG. 1 illustrates a work vehicle, such as a compact track loader 10, including a chassis 14 and traction members (e.g., crawler mechanisms 18) for supporting and propelling the chassis 14 along a surface. The vehicle 10 further includes an operator cab 22, and a tool or work attachment (e.g., a bucket 30) is supported on an end of an arm 34. In the illustrated embodiment, each crawler mechanism 18 includes a drive sprocket 42, an undercarriage frame 46 coupled to the chassis 14, and a track 50. The drive sprocket 42 is driven by a motor 54 and engages the track 50, which is itself driven in an endless loop around the drive sprocket 42 and the undercarriage frame 46.

Although the work vehicle 10 is illustrated and described as a loader, it is understood that the work vehicle may have a different form, such as an excavator, a dozer, a motor grader, a scraper, or another type of construction, mining, agricultural, or utility machine. Also, although the work attachment is illustrated and described as a bucket, it is understood that the work attachment may have a different form, such as an auger, a breaker, a ripper, a grapple, or some other type of attachment for digging, breaking, handling, carrying, dumping or otherwise engaging dirt or other material. In addition, the work attachment may be detachable from the arm 34 to permit another type of work attachment to be coupled to the arm 34.

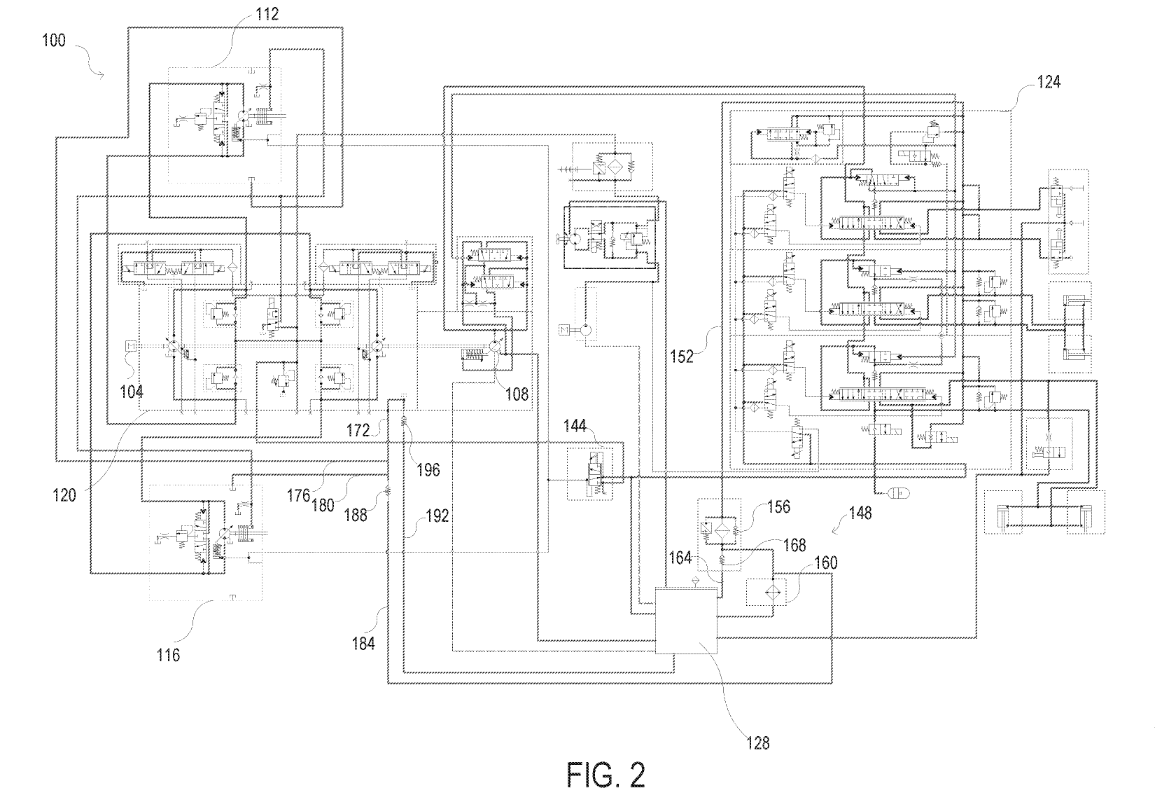

With reference to FIG. 2, the arm 34 is moveable via a hydraulic system 100. In other words, the hydraulic system 100 drives a series of actuators to move the arm 34. The hydraulic system includes a prime mover 104, a hydraulic pump 108, a left motor 112, a right motor 116, and a hydraulic drive device 120.

The prime mover 104 may be an electric motor, an engine, and/or the like. The prime mover 104 is configured to provide power to the hydraulic drive device 120 which, in turn, drives the hydraulic pump 108. Driving the hydraulic pump 108 drives a main control valve 124, which constitutes a batch of valves, to control operation of the arm 34.

In particular, the hydraulic pump 108 is configured to pressurize hydraulic fluid stored in a tank 128 and deliver the pressurized fluid to the main control valve 124. An output fluid tube 132 from the hydraulic pump 108 includes a compensator 136, which compares the pressure of the hydraulic fluid after exiting the hydraulic pump 108 to ensure that the output hydraulic fluid includes sufficiently high pressure. The main control valve 124 additionally supplies pilot pressure to the compensator 136. In other words, the main control valve 124 operably controls flow from the hydraulic pump 108 to control the arm 34.

The hydraulic drive device 120 includes a driving circuit for driving the left motor 112 and a driving circuit for driving the right motor 116.

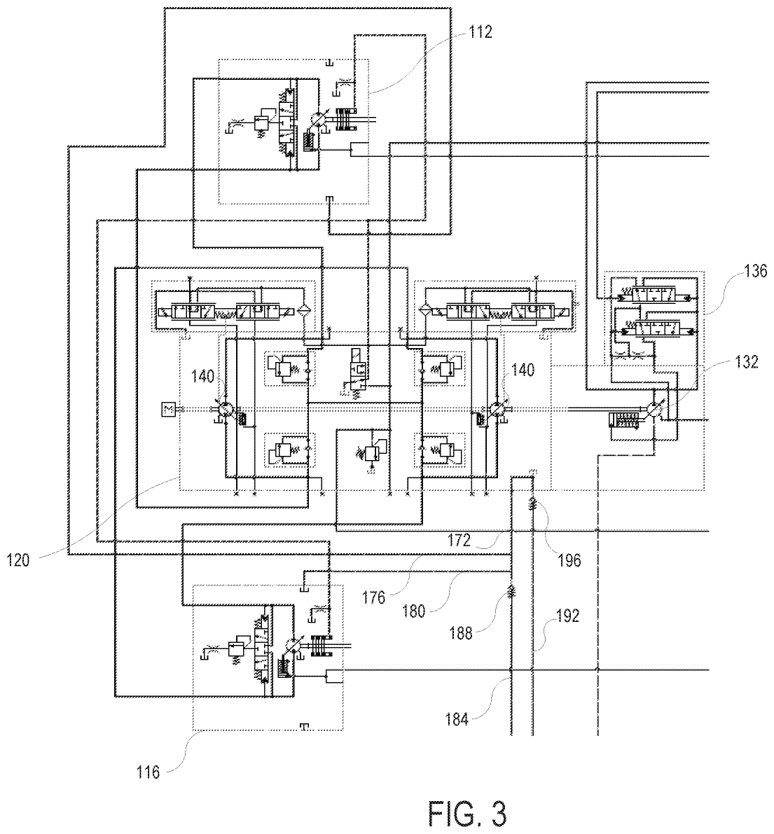

With reference to FIG. 3, each of the driving circuits has a hydrostatic pump, or an HST pump 140 configured to be driven via the prime mover 104. The HST pump 140 is a variable capacity axial pump having a swash plate and a forward pressure receiving portion and a backward pressure receiving portion to which pilot pressure is applied. Pilot pressure applied to the pressure receiving portions alters the angle of the swashplate, thereby changing the output of the HST pump 140 and the resultant torque applied. The HST pumps 140 each increase the pressure of the fluid for delivery to the right and left motors 112, 116, respectively. In other words, the HST pumps 140 drive the right and left motors 112, 116.

The left motor 112 is configured to transmit power to a drive shaft disposed on a left side of the work vehicle 10. The right motor 116 is a motor configured to transmit power to a drive shaft disposed on the right side of the work vehicle 10. A transmission shift valve 144 (shown in FIG. 2) supplies pilot pressure to the left and right motors 112, 116, which adjusts the swash plate. Adjusting the swash plate alters a drive shaft speed and torque ratio of the drive shaft for a given input.

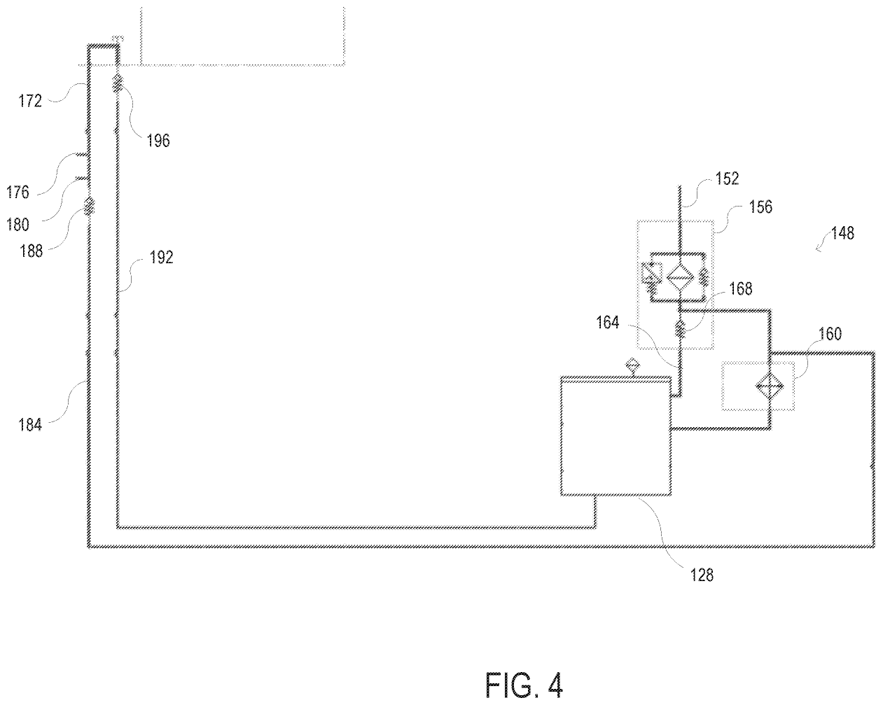

With reference to FIGS. 2 and 4, the hydraulic system 100 further includes a series of drains to drain excess hydraulic fluid from the HST pump 140, the left motor 112, the right motor 116, and the main control valve 124.

A main return circuit 148 is provided to drain excess hydraulic fluid from the main control valve 124. The main return circuit 148 includes a main line 152 coupled to an input and an output of the filter 156. A cooler 160 is disposed within the main line 152, which leads to the tank 128. The cooler 160 is positioned downstream from the filter 156.

A high pressure cooler bypass 164 is disposed in the main return circuit 148. The high pressure cooler bypass 164 runs from the filter 156 to the tank 128, thereby bypassing the cooler 160. In other words, the high pressure cooler bypass 164 branches from the main line 152 proximate the filter output and is coupled to the tank 128 such that the high pressure cooler bypass 164 is solely coupled to the filter 156 to the tank 128. A cooler relief valve 168 at an entry of the high pressure cooler bypass 164 allows entry of hydraulic fluid into the high pressure cooler bypass 164 when the pressure of the hydraulic fluid is sufficiently high. In one embodiment, sufficiently high is defined as an absolute pressure of above 80 psi. In additional embodiments, the cooler relief valve 168 may allow flow at pressures below 80 psi. The high pressure cooler bypass 164 protects the cooler 160 from inclement return pressure spikes. In other words, the high pressure cooler 160 allows hydraulic fluid that has a high pressure to directly enter the tank 128. This prevents undue strain on the cooler 160 due to the high pressure of the fluid.

Additional drains are provided that extend from the HST pump 140, the left motor 112, and the right motor 116. The drain running from the HST pump 140, referred to as the HST line 172, is teed with the drain running from the left motor 112, referred to as the left motor line 176, and the drain running from the right motor 116, referred to as the right motor line 180. The HST line 172, the left motor line 176, and the right motor line 180 merge to form a singular case drain 184, within which is positioned an isolator check valve 188. Downstream of the isolator check valve 188, the singular case drain 184 discharges to the main return circuit 148, merging with the main line between the filter 156 and the cooler 160. In other words, the singular case drain 184 is coupled to the main line 152 between the filter 156 output and the cooler 160 input.

The HST line 172 includes a low pressure bypass 192 branching therefrom prior to the HST line 172 merging with the left motor line 176 and the right motor line 180. The low pressure bypass 192 directly couples the HST line 172 to the tank 128. In other words, the low pressure bypass 192 is coupled to solely the HST line 172 and the tank 128. A check valve 196 in the bypass 192 permits flow of the hydraulic fluid when the pressure of the hydraulic fluid is below an absolute pressure of 25 psi. In additional embodiments, the check valve 196 may allow fluid flow when the pressure of the hydraulic fluid is above 25 psi.

Drains are also provided from the pump to the tank, and from the transmission shift valve to the tank. These drains run directly from the pump and the transmission shift valve, to the tank, without additional filters or bypasses. In some embodiments, these drains may include filters, bypasses, branches, and the like. Additional embodiments may include additional drains and/or additional components. In operation, the main line 152 directs the excess hydraulic fluid from the main control valves 124, through a filter. If the absolute pressure is below 80 psi, the hydraulic fluid is then directed through the cooler 160. The cooled fluid is then directed to the tank 128. If the absolute pressure is above 80 psi, the hydraulic fluid enters the high pressure cooler bypass 164. The high pressure cooler bypass 164 directs the hydraulic fluid that has passed through the filter, directly to the tank 128.

Additionally, the HST line 172, the left motor line 176, and the right motor line 180 drain fluid from the HST pump 140, the left motor 112, and the right motor 116, respectively, to a singular case drain 184. The fluid is then directed through an isolator check valve 188. Thereafter, the fluid is discharged in the main line 152 and is subsequently cooled by the cooler 160. The cooled fluid is then directed to the tank 128. The low pressure bypass 192 is used when the pressure drop of the fluid is high due to cold weather. If the absolute pressure of the fluid in the HST line 172 is above an absolute pressure of 25 psi, the fluid is directed to the tank 128. This protects the HST pump 140, the left motor 112, and the right motor 116 from developing drain pressures that could cause damage to internal components.

Thus, the disclosure provides, among other things, a hydraulic system including case drains with a low pressure bypass and a high pressure bypass to prevent the hydraulic system from undue strain. Various features and advantages of the disclosure are set forth in the following claims.

What is claimed is:

1. A hydraulic system for a working machine, the hydraulic system comprising:
a hydrostatic pump configured to be driven by a prime mover;
a tank configured to store fluid drained from the hydrostatic pump;
a cooler positioned upstream of the tank;
a first conduit coupling the hydrostatic pump to the cooler; and
a second conduit directly coupling the hydrostatic pump to the tank, the second conduit being fluidly isolated from the first conduit.

2. The hydraulic system of claim 1, further comprising a hydrostatic motor configured to be driven by the hydrostatic pump.

3. The hydraulic system of claim 2, further comprising a third conduit configured to couple the motor to the cooler, and a check valve connecting the third conduit and the first conduit.

4. The hydraulic system of claim 1, further comprising a main control valve operable via a hydraulic pump configured to be driven by the prime mover.

5. The hydraulic system of claim 4, further comprising a fourth conduit coupling the main control valve to the cooler.

6. The hydraulic system of claim 5, further comprising a fifth conduit coupling the fourth conduit, upstream of the cooler, to the tank.

7. The hydraulic system of claim 5, wherein the fourth conduit couples the main control valve to a filter upstream of the cooler.

8. A work vehicle comprising:
a prime mover;
a chassis;
a plurality of traction members for supporting and propelling the chassis along a surface;
a work attachment supported on an end of an arm; and
a hydraulic system configured to receive power from the prime mover and to move the arm and the plurality of traction members, the hydraulic system including,
a hydrostatic pump configured to be driven by the prime mover,
a tank configured to store fluid drained from the hydrostatic pump,
a cooler positioned upstream of the tank,
a first drain connecting the hydrostatic pump to the cooler, and
a second drain connecting the hydrostatic pump to the tank and not to the cooler the second drain being fluidly isolated from the first drain.

9. The work vehicle of claim 8, wherein the hydraulic system includes a hydrostatic motor configured to be driven by the hydrostatic pump.

10. The work vehicle of claim 9, wherein the hydraulic system includes a third drain connecting the motor to the first drain, and a check valve connecting the first drain to the third drain.

11. The work vehicle of claim 8, wherein the hydraulic system includes a main control valve operable via a hydraulic pump for controlling the arm, the hydraulic pump configured to be driven by the pump.

12. The work vehicle of claim 11, wherein the hydraulic system includes a fourth drain connecting the main control valve to a filter positioned upstream the tank.

13. The hydraulic system of claim 12, wherein the hydraulic system includes a fifth drain connecting the filter to the tank.

14. A hydraulic drain system for a working machine, the hydraulic drain system comprising:
a first conduit coupled to a first hydrostatic pump, a second hydrostatic pump, and a cooler, the cooler positioned upstream of a tank; and
a second conduit coupled to the first hydrostatic pump, the second hydrostatic pump, and directly to the tank, the second conduit not connected to the cooler, wherein the second conduit is fluidly isolated from the first conduit.

15. The hydraulic drain system of claim 14, further comprising a third conduit coupled to a first motor, the first conduit, and the cooler, a check valve positioned between the first conduit and the third conduit, and wherein the first motor is driven by the first hydrostatic pump.

16. The hydraulic drain system of claim 15, further comprising a fourth conduit coupled to a second motor, the first conduit, and the cooler, and wherein the second motor is driven by the second hydrostatic pump.

17. The hydraulic drain system of claim 14, further comprising a fifth conduit coupled to the tank, the cooler, a filter, and a main control valve.

18. The hydraulic drain system of claim 17, further comprising a sixth conduit coupled to the filter and the tank, the sixth conduit not connected to the cooler.
